(19) United States
(12) Patent Application Publication
(10) Pub. No.: US 2002/0063901 A1
(43) Pub. Date: May 30, 2002

(54) Method for storage, retrieval, editing and output of photographic images

(76) Inventor: Ray Hicks, Fenton, MI (US)

Correspondence Address: Milton S. Sales, Patent Legal Staff, Eastman Kodak Company, 343 State Street, Rochester, NY, 14650-2201, US

(21) Appl. No.: 10/008,032

(22) Filed: Nov. 5, 2001

Related U.S. Application Data
(60) Provisional application No. 60/253,006, filed on Nov. 27, 2000.

(51) Int. Cl. H04N 1/21

(52) U.S. Cl. 358/302

(57) ABSTRACT

The invention is a method of editing, storing and using digital photographic images for the purpose of producing finished collections of photographs. In the inventive method, digitized photographic images are first combined with editing information, and that combination is utilized by the originating photographer to prepare the finished photographs. The originating photographer also provides instructions for further editing, collating, masking and grouping the photographs for presentation and sale over a network, such as the Internet.

### FIELD OF THE INVENTION

The invention pertains to methods for storing and editing photographic images, and more particularly, methods for storing and editing photographic images in digital form, facilitating output of said images in printed form in individual, matted and album formats.

### BACKGROUND OF THE INVENTION

Commercial photography is an industry with many facets. Mainstream commercial photography is seen in familiar venues: School photographers photograph entire populations of grammar schools, high schools and universities. Event photographers are seen at parties, weddings and other celebrations. Other photographers specialize in the preparation of images for advertising, such as in magazines and catalogs. More specialized photographers may limit their work to architectural subjects or sports events. Regardless, all of the foregoing photographers earn their income from the sale of printed photographs following completion of the actual photography of the subjects.

Until recently, the transfer of the photographic image from the exposed film to paper has been performed in a process more than a century old. The photographic film is developed into negatives, the images from which are projected onto sensitized paper which is then developed, producing a finished photograph. It has long been known that shortcomings or limitations of the original photographic image can be overcome, to some extent, by skillful editing in the photographic laboratory.

Starting with the most fundamental editing, for example, a single negative of a student from a school class is commonly used to create multiple photographic images of different sizes. Such blowups or reductions are among the simplest editing tools of the photographic laboratory. Likewise, the photographic image may be cropped; the color balanced, brightness and contrast of the image may be changed or improved. More sophisticated and individualized techniques may be used to remove or reduce the appearance of scarring or blemishes on the face of a human subject. A wide variety of laboratory editing techniques have developed over the last century enabling professional photographers, working in conjunction with the laboratories, to produce an attractive finished print.

A second common step in the process of the photographer's sale of photographic prints to the ultimate customer is the framing, matting and organization into albums of photographic images. To make photographs more visually appealing, it is common to provide them with a surrounding border element, which may, using current technology, be integrated with the photographic print itself. Moreover, modern imaging technology permits the incorporation of photographic images into a more traditional printed media, such as greeting cards, postcards, lapel buttons and the like. It is also desirable to prepare collections of certain photographs, such as the traditional “wedding album” using an aesthetically pleasing collection of photographs arranged appropriately, which arrangements may include multiple photographs using multiple aperture-type mattes arranged in a bound photographic album.

Photographers have also learned that for many types or celebrations, both sponsors and guests are often interested in obtaining copies of the photographs from the event. While wedding pictures, for example, have traditionally been sold to the bride and groom and their families, it has been learned that utilizing appropriate sales techniques, many guests at a wedding will also be interested in acquiring a small portfolio of photographs memorializing the event.

Photographic laboratories, however, are profitable only when processing a large volume of photographic film. A typical photographic laboratory will process thousands of photographic images every week. Likewise, professional photographers produce large numbers of photographic images for an equally large number of clients, creating significant logistical problems in the editing, sale and delivery of quality finished products to the ultimate customer.

Historically, the photographic image sales process has required the preparation by photographic laboratories of “proof” prints, a series of basically unretouched photographic prints of uniform size. These proof prints have traditionally been physically delivered from the laboratory to the photographer, who then meets with the customer or photographic subject to display the photographs, discuss the respective merits of each, and collectively choose a series of photographs for purchase, matting, framing and/or incorporation in an event album.

The selection and editing of multiple images against the previously described high volume background creates significant opportunities for error, and limits the opportunity for sale of photographic images to others, such as guests at a wedding. Further, the manual method above-described requires a great deal of cross-tabulation. To maintain sequences of albums, pages, mattes, orientations of matts and images, images, image location in relation to the matte, image sizes, cropping and composition of images require the attachment of a specific negative to an “aperture card”.

Some of these problems were resolved by incorporating a computer into the process, to assist in keeping track of the foregoing variables. The cropping and composition tasks, however, generally remained a manual operation. While, in the prior art, databases were used to drive and order prints and album components, there has been only limited automation available for print ordering.

In addition to the foregoing, it is now well known to utilize electronic data imaging for the proofing and preparation of photographic prints. Photographic images may be captured directly to digital film, or conventional photographic negatives may be scanned to create the data files containing the images stored in digital format. It is also well known to make such digital images available for presentation on both local and remote computer screens, thereby allowing customers and photographers to preview, and in a limited sense, to remotely edit the images, which can then be reproduced either in another digital format (e.g., on a CD ROM), or in some printed media. Examples of this type of technology are found in my U.S. Pat. No. 5,512,396, Re. 36535. Digital editing and delivery of photographic images has now become a commonplace tool in the Internet environment.

It is also known to utilize various digital methods for assembling a photographic album. See, for example, Norris, U.S. Pat. Nos. 5,864,411 and 5,563,722. The '411 and '722 patents, for example, teach a method and apparatus for arranging photographic images in a photographic album utilizing digitized images of both the photograph and the matte, and further utilizing said combined images to create photographic albums. This method and apparatus, however, has a number of shortcomings. First, the Norris inventions do not provide for variations in image grouping. Further, there is no provision in the prior art for specialized sizing cropping, and custom composition (e.g., tilting). Finally, the existing technology does not provide an interface to the network environment, and more particularly, to the Internet.

### SUMMARY OF THE INVENTION

Review of the existing art will make it apparent that there is a need for an improved method of maintaining and utilizing a database of photographic images and related components to specify image, frame, matte, background and photographic album parameters which can be used to drive an automated process for the production of finished photographic products comprised of photographs and other elements.

In the present invention, the photographer is provided the necessary tools to interactively receive and store photographic images. Utilizing these images, the photographer crops, composes, or otherwise edits one or more photographs. Once the photographer has edited the images and associated elements, he or she is able to specify production of the images by providing a collection of information electronically to the laboratory, for the laboratory to use in the production of the images. The parameters which the laboratory uses for the production of images are derived directly from the editing actions and instructions provided by the photographer. The information received from the photographer is used to build a database of parameters uniquely associated with the photographer's images. Included in these parameters are the specification by the photographer of a selected group of the images in a predetermined order, and may further include information assigning the images to specific groups, such as a school class or club. The photographer may select multiple sets of parameters, for example, he may select a prime set of photographs to be used for offer to sale to a prospective class of purchasers, and a completely different array of photographs to be offered to a sub-class or different class of purchasers involved in the same photographic event. The same images may be published electronically to an Internet web side for presentation to other interested potential purchaser of photographs, and presented in such a way that such purchasers may order product directly from the photographer over the Internet.

The original photographic images remain cataloged and stored, in association with the original photographic film, at the photographic laboratory. Subsequent re-scanning of the film, if necessary, can utilize the same database of information to reincorporate into the ultimately used images, the appropriate editing parameters previously used by the photographer.

A second element of the invention involves the incorporation of all of the foregoing edited photographic groups into albums having a desired styles, colors, materials and other aesthetic treatments. Each page of a proposed photographic album may also be provided with a matte having a particular style, color and other aesthetic elements. A matte may have single or multiple apertures allowing for multiple images to be displayed on a single page, and the apertures may be of various sizes, shapes and positions, as well as orientations. Utilizing this electronic album, page background, matt and other elements, the photographer's images may be merged with the album, thereby radically simplifying an otherwise complex task for the photographer. The photographer may receive his images, and sort them into groups for convenience. The photographer can then select certain images to build a special group that will represent a photographic album of images in some desired order. The photographer will then specify a particular album and its sub-components, including page type, matts and orientation. The photographer is able to build this group of pages utilizing graphic representations of the album pages, backgrounds and mattes on the video screen of a computer. He may combine the photographic images and the album parameters so defined so that they may be previewed, both by the photographer and his customer, either by the production and conventional transmittal of paper copies, or on the photographer's web site on the Internet. In this fashion, the ultimate customer can participate to a significant degree in the design and production of his or her own photographic collection.

This selection operation results in the transmission of data to the photographic laboratory, which causes additions and modifications to be made to the existing database associated with the photographic images. Once the photographer has completed the selection of photographs and associated presentation elements, including albums, the information so provided is utilized to allow both production of the finished product, as well as to permit ordering, over the Internet, by other interested third parties of all or part of the photographs or photographic collections so designated.

In the present system, the photographer is provided with the option of substantial customization of the ultimate appearance of the photographic album. In my invention, the photographic image associated with any matte and album page can be selectively oriented, tilted or otherwise composed, and subject to one or more cropping steps. This improvement broadly expands the range of options available to the photographer and the photographer's ultimate customer. Moreover, the images ultimately selected and organized, in my system, are simultaneously available to other prospective purchasers by utilization of wide area network technology, such as the Internet.

### BRIEF DESCRIPTION OF THE DRAWINGS

FIG. 1 is a flow chart of the fundamental steps of the invention; and

FIG. 2 is a schematic diagram showing the flow, input and presentation of data according to the method of the invention.

### DETAILED DESCRIPTION OF THE INVENTION

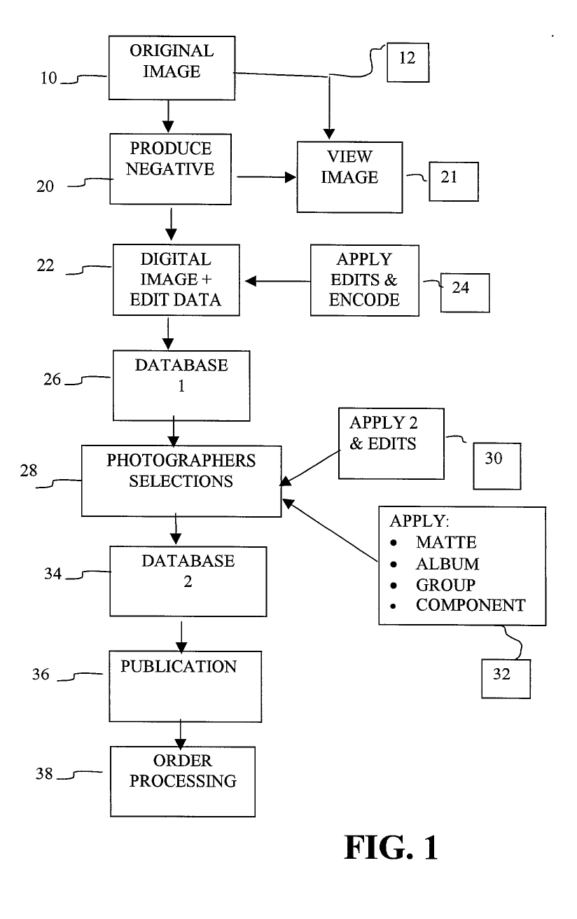

My invention will best be understood first by reference to FIG. 1, which outlines the principal methodology utilized. In every case, the initial step in the process begins with the capture of an image of the photographic subject. This original photographic image 10 may be made using traditional photographic processes, i.e., a film camera, or may involve the direct digital capture of an image through the use of a digital camera or other digital imaging device.

In the event that the original image 10 is from a conventional film camera, the method follows path 14, whereby the film from the film camera is processed in the traditional chemical fashion to produce either a negative or transparency image 20. The chemical process for the production of such images is well known in the art.

In the event that the original image is captured using digital photography, the method then follows path 12, wherein the digital image is presented to an image-viewing device according to step 21 allowing the original image to be subjected to preliminary inspection. The image viewing device is typically an image capture and encoding station of the type manufactured by Proshots, Inc. Such image capture and encoding stations produce, for example, conventional positive images from negative film in the form of data presented on a computer monitor, and likewise are capable of displaying digital data from digital camera exposures in the same fashion. This equipment, therefore, allows the presentation to a photographic laboratory operator of a raw digital image which proximates the image of the photographic subject which may eventually be produced as a finished print. At this stage of the process, the laboratory will encode the exposure, providing to each discrete photographic frame a corresponding code number to identify the photographic frame for further processing. At the same time, the laboratory will apply 24 initial editing parameters to each photographic image. Certain flawed photographic images (such as a “blink”, i.e., photograph of a human subject with its eyes closed) can be discarded, preliminary color corrections affecting entire sequences of exposures may be made, and preliminary orientation and cropping instructions can be applied for each exposure. Following the application of this type of editing and encoding information, the laboratory creates a combined digital image in Step 22, including editing data of each frame. The collection of frames associated with each photographic job (for example, the exposures of a subject in a single photographic sitting, all of the photographs associated with a particular event, such as a wedding) are combined into a first data base 26, which includes the raw digital images 10 of all selected frames, together with the associated encoding and editing information applied in step 24. An additional editing step which can take place at the laboratory, at the same time that Step 24 is performed, is the addition of external “components” such as watermarks or photographer's logos to each frame. These same types of components can be added later in the editing process as will be more fully described herein.

This initial data base is then transmitted, either by conventional removable electronic media, such as CD ROM, or over a wide area network such as the internet, to the originating photographer for final editing, print selection, grouping, matting and collation.

The first data base 26, once having been transmitted to the originating photographer by any of the aforedescribed means is then viewed by the photographer and analyzed. As a preliminary step, the photographer is likely to discard a large number of exposures as unsuitable based on a variety of artistic criteria. Ultimately, the photographer will select the best of a group of photographic exposures to present to his client for consideration for purchase. Once that initial selection has been made, the photographer will apply specific edits to some or all of the selected photographs. This application of a second set of edits 30 is likely to include such things as the correction of skin blemishes, the elimination of unwanted reflections, lens flare or background objects, and the fine adjustment of colors and color balance. Modem photographic image processing software provides to the commercial photographer a broad palette of editing tools which can be utilized for these purposes.

Once the photographer has completed the selection 28 of photographs and applied 30 the second set of editing parameters, all of the image selection and editing data is incorporated into a second data base 34 associated with the first data base 26. This incorporation may be accomplished by the actual modification of the digital image data contained within data base 1, or may take the form of the creation of a separate data base of second editing information which will be subsequently used to modify the images contained within data base 1. Frequently, it is desirable to permit the original raw images to remain undisturbed throughout the process to permit repetitive and recursive editing of the images, with the assurance that the original images is always available for reevaluation and re-editing without the need for the photographer to reshoot any or all of the original photographic subjects.

The next step in the editing process is the application 32 by the photographer of organizational edits and the establishment of photographic groups or collections, all of which will serve to improve the photographer's potential for sale of the photographic images. First, it may be desirable to display one or more photographs on a single page in conjunction with a matte. A matte is a stylized border which is designed to form a pleasing frame around one or more photographs. Photograph matting is a well known technique which, prior to the evolution of digital imaging, was typically performed with a physical masking of a collection of photographs with a matting frame having a variety of apertures forming a border around the picture or pictures presented on a single page. With the advent of digital processing, however, it is not only possible, but convenient, to incorporate the matte as part of the digital image itself. As a result of the flexibility offered by the digital interposition of a matte in association with a collection of photographs, a large number of matte designs have become commercially available. Presently, software products are available and offer literally thousands of combinations of matte groupings, colors and styles. Utilizing the method of the present invention, the photographer's selections, as edited, may be conveniently combined with a wide variety of mattes. The software provided with my invention automatically selects the appropriate size image to be associated with a particular matte frame. To combine a matte frame and photographic image utilizing the software of my invention, the photographer simply selects a desired photographic image and a desired matte and “drags” and “drops” the image utilizing well known techniques, into the matte frame presented on a computer monitor. The software determines the printed dimensions of the matte frame opening, and compares those dimensions to the dimensions of the selected image. Each matte opening has a predetermined physical size, and a predetermined vertical and horizontal center line. When an image is dragged and dropped into a matte, this predetermined pixel size and center line location is compared to the physical size of the selected image, as well as predetermined horizontal and vertical center line of the image. Accordingly, the juxtaposition of the image and the matte is always appropriately centered, and the size relationship of the image to the matte opening is correct.

In addition to the creation of single pages of matted photographs, the originating photographer is also most interested in promoting the sale of collections of several pages, photographs in the form of a photographic album. Just as in the case of matting, computer software is commercially available for the collation of a collection of matted pages into a single photographic album layout. Such techniques, for example, permit the orientation of adjoining pages of photographs to permit a single photograph to span two pages of a single photographic album. Accordingly, the photographer may also select album information. This album information is stored as additional digital data in association with the matting information for further processing of the photographic job. It is also possible for the photographer to select multiple albums to be available for single photographic job.

Next, the originating photographer will evaluate the desirability of establishing different “groups” or collections of photographic images for marketing purposes. Using the typical wedding photographic job as an example, it is likely that the wedding participants and their immediate families will be interested in purchasing rather comprehensive photographic album collections of the wedding. More distant relatives and friends may consider the purchase of a scaled down wedding album, whereas other wedding guests may be interested in purchasing a single page collection of photographs depicting, for example, a major wedding scene, and an other photograph in which the customer himself may be found. Accordingly, the photographer will find it desirable to create a plurality of groupings or “groups” of photographs which may be offered to a broad range of customers, and from which they may select photographic collections of broad or limited scope and corresponding costs. The identification of photographs and their parameters constituting these groups is also stored as digital data for further processing.

Finally, the photographer will frequently find it desirable to insert in association with the photographs and their matting certain caption watermarks, titles or advertising information, e.g., the name and address of the photographer himself. These types of components, which are also widely available as stock items from commercial collections, are also stored as digital data. It is therefore desirable to apply matte, album, group and component data 32 with second editing data 30 to constitute the final photographer's selections 28 in the form of a data base 34. At this point, the finished photographic job is organized in a second data base 34 for convenient presentation to the client and other prospective customers. The publication of the information contained in second data base 34 can take place in several forms. First, traditional proof-type images can be printed and presented on paper. Alternatively, computer media, such as a CD ROM may be distributed for convenient viewing on the personal computers of prospective customers. More frequently today, however, the data is placed in a publicly accessible file on a server at either the photographic laboratory or the photographer's studio, and prospective customers are invited, by internet solicitation, to access the server after having been provided with the appropriate file name and password. In this fashion, prospective customers may, from their homes and offices, view the photographic collections created by the photographer and be provided with an opportunity to order one or more photographic prints online. The order processing system is conventional. The groups consisting of edited photographs organized into one or more matted pages or albums is presented over the network, and each potential customer is permitted to freely examine all of the various combinations of images offered by the photographer. This information may be submitted over the internet, or may likewise be submitted by transmission of removable computer media or traditional paper order forms. The next part of the order processing step 38 is a presentation to the photographic laboratory of the order information obtained from the customer. Inasmuch as the photographic laboratory has received all of the necessary editing information from the photographer and has created and established the second data base 34, the photographic laboratory may process the customer orders directly without further instructions from the photographer. As each order is filled, the originating photographer is advised, as is the customer. Typically, this information is transmitted over a network, such as the internet. Order processing step 38 includes the presentation to the photographer of billing information, so that the photographer may charge the end customer directly for the photographs produced by the laboratory. Likewise, automated billing information is transmitted from the photographic laboratory to the photographer, so that the photographer may be appropriately billed by the laboratory for the cost of the production of the finished prints and albums.

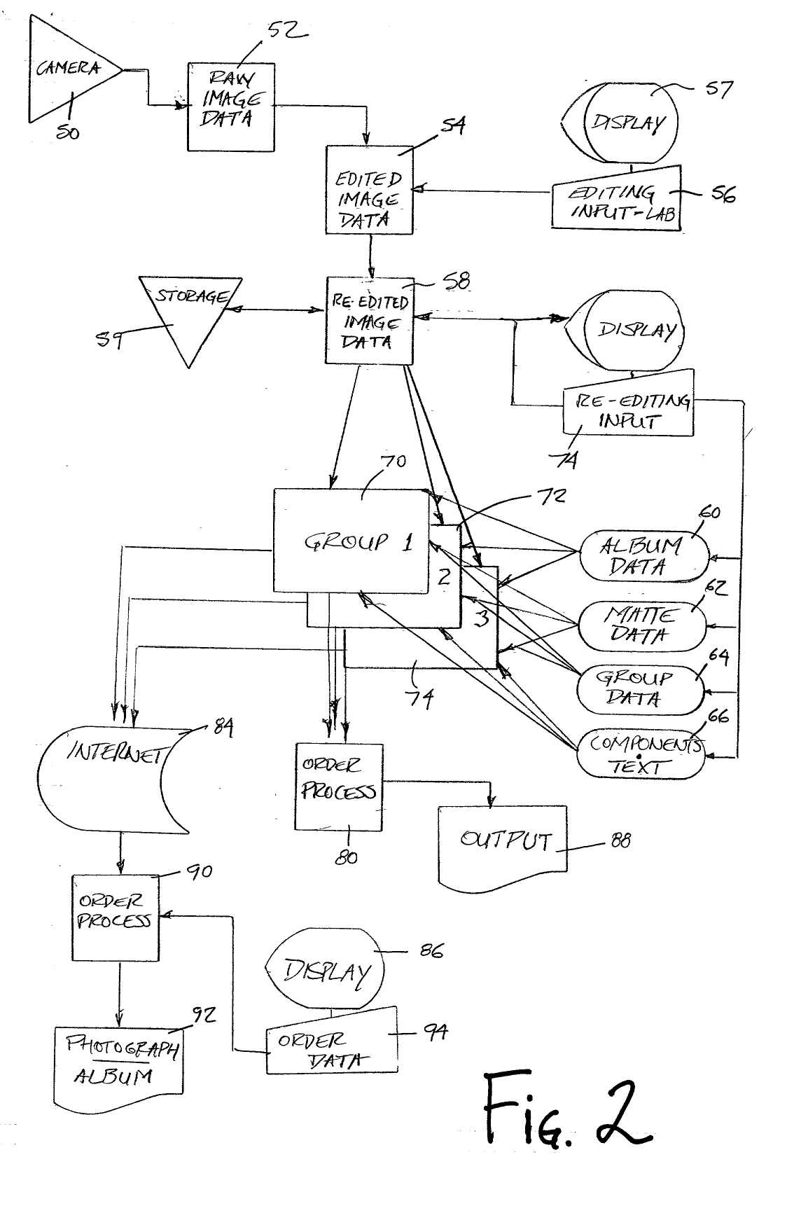

A more thorough understanding of the flow of data through the system will be obtained from the following description and a study of FIG. 2. The original photographic image is captured by a camera 50. As above-described, camera 50 may be either a conventional film camera or a digital camera suitable for the direct capture of a digital image data file. In the event that conventional film cameras are used as the image capture device, it is necessary that the film be developed and presented to a digitizing device to derive initial image data 52. Regardless of whether a digital or film camera is used for the initial image capture, the image data 52 which forms the basis for all further processing, is initially stored in a digital computer memory device, such as random access memory, CD ROM, fixed or removable hard drive, or magnetic tape. Regardless of the method of storage of image data 52, it is necessary, for further utilization of the inventive method, that the initial image data be preliminarily edited. Editing of the image data requires the initial step of providing an identifier or code for each individual image. Typically, this is done by providing a punch code or bar code on the edge of negative film, but may just as easily be accomplished by the association of a discrete digital code with each frame of image data 52. The provision of such a discrete code insures that each frame of image data will be easily identified throughout the editing, re-editing, order processing and output processing steps.

Initial editing input 56 is conventionally obtained at the photographic laboratory once the initial image data 52 has been captured and presented, for example, on a display 57. High quality computer displays are capable of presenting a near photographic quality image of the raw image data 52. In one embodiment of my invention, a human operator provides editing input 56 to the raw image data 52 to produce a database of edited image data 54. The edited image data 54 for each individual photographic frame will initially include a preliminary selection criteria, i.e., whether or not to use the frame at all. Many photographic images are spoiled at the time of exposure for a variety of reasons. There may be undesirable reflections, blurred images, poor exposures, double exposures, “blinks” or other fundamental defects which render the image useless for further image processing. Accordingly, at the laboratory these frames may be marked for deletion from any further processing. Once such “discard” frames have been identified and flagged, the photographic laboratory will also view the entire collection of frames for fundamental printing corrections, such as color balance. Anomalies in film or lighting may suggest to the laboratory a universal color correction to be applied to all of the photographs from a particular roll of film, for example. This type of editing input 56 combined with raw image data 52 produces edited image data 54 which is then stored in conventional computer storage media 59. The edited image data is then made available to the originating photographer. In one embodiment of my invention, the edited image data 54 so stored is accessible over a network to the originating photographer who may view and provide editing input from a conventional personal computer 74. The edited image data 54 presented to the originating photographer may be manipulated by the original photographer utilizing a wide range of photographic image processing software, such as PhotoShop□. The originating photographer will analyze each usable exposure and apply his or her own artistic input to create re-edited image data 58. Because of the versatility of modem photographic image processing software, originating photographer is provided with powerful tools for the re-editing of the raw image data and the corresponding creation of a finished group of photographic images which will be pleasing to the photographer's client. Moreover, the originating photographer has available to him a wide variety of commercial matte data 62, album data 60, as well as component and text data 66 with which to enhance present and organize the photographic images into esthetically pleasing collections or groups which may be separately identified by the selection of group data 64. Album data 60, matte data 62 and component/text data 66 can be selectively applied to group data 64 to create product groups 70, 72 and 74 for example. Each product group 70, 72 and 74 can consist of a unique photographic album having unique matting, a unique collection of photographs and a unique collection of components and text. In this fashion, a comprehensive collection of dozens of photographs may be organized into an impressive album as group one, and, at the other end of the scale, a single page of matted photographs organized as group three, presenting to prospective customers a broad spectrum of offerings from which to choose and purchase. Although FIG. 2 depicts only three groups 70, 72 and 74 of photographic products, it can be readily seen that the number of groups is virtually limitless, and the true commercial limits of the offering is the time required by either the photographer or the prospective customer to view and select a desired photograph collection. Once one or more groups have been created they are available for immediate order processing 80 by direct instructions from the photographer or his client. Direct order processing 80 is facilitated by the ability of the photographer to display 82 for the client, either in the client's company or over the internet, a comprehensive collection of images organized into groups. Such direct order processing may result in the immediate production by the photographic laboratory of the photographic album 88.

Likewise, the groups may be loaded to a computer server, at either the photographic laboratory or at the photographer's studio and available for transmission over the internet. This internet storage and transmission 84 permits potential customers to display and purchase photographic image groups. In a typical internet marketing environment, the potential customers for one or more groups of photographs is notified by e-mail or more conventional methods of the availability of photographic images for viewing and ordering on the internet. Prospective customers are provided with an internet address and password so that the customer may visit the photographer's web site and view all of the individual photographs as well as the groups offered for sale by the photographer. Since the photographic images so offered for display are of relatively low resolution, they are of virtually no commercial value to prospective customers.

Once a potential customer has made a decision to buy one or more groups of photographs, the order process begins. The customer is invited to fill out shipping and billing information utilizing the internet and edit order data 94 is transmitted to the photographic laboratory. The group data having been stored and maintained as an identifiable and discrete data base at the server site, the photographic laboratory is able to automatically process the order without further input from the originating photographer. The internet ordering process preferably results in billing to the customer directly from the originating photographer, wherein the photographic laboratory will transmit its billing for production of the finished product directly to the photographer in the usual course of business. Since the hourly cost associated with the presentation of the photographic product is the cost of storage of the group and edited image data on a server, it is practical for both the photographer and the laboratory to maintain a long term availability of product, allowing prospective customers to purchase product months, even years after the original event. Likewise, because the photographer has been able to present a variety of collections of esthetically pleasing quality of the photographed event, the originating photographer's marketing opportunities are enhanced.

1. A method of editing, organizing and distributing photographic prints comprising:
capturing an image of photographic subject;
converting said image to a digital image;
viewing said digital image;
applying preliminary edits to said image;
storing said edits as digital data associated with said digital image; creating a database of a plurality of said digital images and said associated digital data;
applying second edits to said digital images;
selecting at least one of said images for presentation on a page;
applying a digital matte element to said selected at least one image; producing a digital page incorporating said at least one image and said applied matte;
presenting said digital page for viewing; storing said digital page in a computer network accessible storage location; and
creating a photographic print from said digital page.

2. The method of claim 1 which further comprises the creation of a photographic album including a plurality of said digital pages.

3. The method of claim 1 which further comprises the addition of digital artistic components to said digital page.

4. The method of claim 2 which further comprises the creation of a plurality of said albums and presentation of said plurality of albums for viewing over a digital network.
